(19) United States
(12) Patent Application Publication
(10) Pub. No.: US 2026/0281923 A1
(43) Pub. Date: Sep. 17, 2026

(54) TIME SYNCHRONIZATION APPARATUS AND TIME SYNCHRONIZATION METHOD

(71) Applicant: ELECTRONICS AND TELECOMMUNICATIONS RESEARCH INSTITUTE, Daejeon (KR)

(72) Inventors: Inone JOO, Sejong-si (KR); Cheon Sig SIN, Daejeon (KR)

(73) Assignee: ELECTRONICS AND TELECOMMUNICATIONS RESEARCH INSTITUTE, Daejeon (KR)

(21) Appl. No.: 19/329,161

(22) Filed: Sep. 15, 2025

(30) Foreign Application Priority Data
Mar. 14, 2025 (KR) 10-2025-0033512

(51) Int. Cl. H04W 56/00; G01S 19/07; G01S 19/11

(52) U.S. Cl. CPC H04W 56/001; G01S 19/07; G01S 19/115

(57) ABSTRACT

The time synchronization method performed by the time synchronization apparatus includes receiving a satellite-based augmentation system (SBAS) message through an auxiliary channel, extracting time synchronization information from the received SBAS message, performing coherent integration on an SBAS signal received through an antenna, based on bit information included in the time synchronization information, identifying, through a frame synchronizer, a start point of a frame in the coherently integrated SBAS signal and outputting a frame sync time, which represents a global positioning system (GPS) time at which the SBAS signal transmitted from an SBAS satellite located in a geostationary earth orbit (GEO) is received through the antenna, and generating, through a GPS time generator, a final GPS time using a GEO transmit time, which represents a GPS time at which the SBAS signal included in the time synchronization information is transmitted from the SBAS satellite and the frame sync time.

### CROSS-REFERENCE TO RELATED APPLICATION

This application claims the benefit of Korean Patent Application No. 10-2025-0033512, filed on March 14, 2025, in the Korean Intellectual Property Office, the entire disclosure of which is incorporated herein by reference for all purposes.

### BACKGROUND

### Field of the Invention

One or more embodiments relate to an apparatus and an operation method for time synchronization using a global positioning system (GPS) signal and a satellite-based augmentation system (SBAS) signal.

### Description of the Related Art

GPS provides positioning, navigation, and timing services and is essentially used in a wide range of applications such as smartphones, vehicle navigation, geodesy and surveying, and precise time synchronization in national infrastructures. Specifically, GPS time synchronization apparatuses are used to achieve precise time synchronization between multiple devices in mobile communication networks, power grids, and financial systems, and play a crucial role in the stable operation of national infrastructures.

Although GPS signals employ code division multiple access (CDMA) techniques and are somewhat resilient to jamming, they are inherently weak in signal strength and may be easily disrupted by strong jamming signals. If the GPS signal is blocked in this way, the GPS time synchronization apparatus may also lose its functionality, which may severely impact the stable operation of national infrastructures.

The above information may be presented as the related art to help with the understanding of the disclosure. No arguments or decisions are raised to whether any of the above description is applicable as the prior art related to the present disclosure.

### SUMMARY

Embodiments provide an apparatus and a method that may offer stable and accurate time synchronization even under jamming environments by combining a satellite-based augmentation system (SBAS) signal and an auxiliary channel.

Embodiments also provide an apparatus and a method that may secure a maximized signal-to-noise ratio (SNR) by performing long-term coherent integration on the SBAS signal.

Embodiments also provide an apparatus and a method that may resolve bit inversion of the SBAS signal by receiving an SBAS message in advance through the auxiliary channel.

However, the technical goals are not limited to those described above, and other technical goals may be present.

According to an aspect, there is provided a time synchronization apparatus that may include an auxiliary channel receiver configured to receive an SBAS message through an auxiliary channel, an SBAS message processor configured to extract time synchronization information from the received SBAS message, an SBAS signal integrator configured to perform coherent integration on an SBAS signal received through an antenna based on bit information included in the time synchronization information, a frame synchronizer configured to identify a start point of a frame in the coherently integrated SBAS signal and to output a frame sync time that represents a global positioning system (GPS) time at which the SBAS signal transmitted from an SBAS satellite located in a geostationary earth orbit (GEO) is received through the antenna, and a GPS time generator configured to generate a final GPS time using a GEO transmit time that represents a GPS time at which the SBAS signal included in the time synchronization information is transmitted from the SBAS satellite and the frame sync time.

The time synchronization apparatus may further include a pseudo range calculator configured to calculate a pseudo range between the SBAS satellite and the time synchronization apparatus based on position information of the SBAS satellite and position information of the time synchronization apparatus, and a real range deriver configured to derive a radio wave propagation time corresponding to a real range by correcting a signal delay caused by the ionosphere and the troposphere during atmospheric propagation of the SBAS signal using signal correction information included in the time synchronization information for the calculated pseudo range, and to derive the real range based on the derived radio wave propagation time.

The GPS time generator may generate the final GPS time by applying the corrected radio wave propagation time, derived by the real range deriver, to the frame sync time.

The SBAS signal integrator may align a phase of the SBAS signal through correlation with a reference signal, identify a bit inversion point in the phase-aligned SBAS signal using bit information included in the time synchronization information, and perform integration on the phase-aligned SBAS signal by inverting data at the identified bit inversion point.

The auxiliary channel receiver may include at least one terrestrial network among 5th generation (5G), Long Term Evolution (LTE), and Wi-Fi.

According to another aspect, there is provided a time synchronization method performed by a time synchronization apparatus including receiving an SBAS message through an auxiliary channel, extracting time synchronization information from the received SBAS message, performing coherent integration on an SBAS signal received through an antenna based on bit information included in the time synchronization information, identifying, through a frame synchronizer, a start point of a frame in the coherently integrated SBAS signal and outputting a frame sync time that represents a GPS time at which the SBAS signal transmitted from an SBAS satellite located in a GEO is received through the antenna, and generating, through a GPS time generator, a final GPS time using a GEO transmit time that represents a GPS time at which the SBAS signal included in the time synchronization information is transmitted from the SBAS satellite and the frame sync time.

The time synchronization method may further include calculating, through a pseudo range calculator, a pseudo range between the SBAS satellite and the time synchronization apparatus based on position information of the SBAS satellite and position information of the time synchronization apparatus, and deriving, through a real range deriver, a radio wave propagation time corresponding to a real range by correcting a signal delay caused by the ionosphere and the troposphere during atmospheric propagation of the SBAS signal using signal correction information included in the time synchronization information for the calculated pseudo range, and deriving the real range based on the derived radio wave propagation time.

The generating of the final GPS time may include generating the final GPS time by applying the corrected radio wave propagation time, derived by the real range deriver, to the frame sync time.

The performing of the coherent integration may include aligning a phase of the SBAS signal through correlation with a reference signal, identifying a bit inversion point in the phase-aligned SBAS signal using bit information included in the time synchronization information, and performing integration on the phase-aligned SBAS signal by inverting data at the identified bit inversion point.

The receiving of the SBAS message may include receiving the SBAS message through at least one terrestrial network among 5G, LTE, and Wi-Fi.

According to another aspect, there is provided a time synchronization method performed by a time synchronization apparatus. The method may include synchronizing a GPS time using a GPS signal received from a GPS satellite, correcting the synchronized GPS time using an SBAS signal transmitted from an SBAS satellite located in a GEO, and maintaining the corrected GPS time using the SBAS signal if the GPS signal is not received due to jamming.

The time synchronization method may further include receiving an SBAS message through an auxiliary channel and performing coherent integration on the SBAS signal based on bit information included in time synchronization information contained in the SBAS message.

The performing of the coherent integration may include aligning a phase of the SBAS signal through correlation with a reference signal, identifying a bit inversion point in the phase-aligned SBAS signal using bit information included in the time synchronization information, and performing integration on the phase-aligned SBAS signal by inverting data at the identified bit inversion point.

The maintaining of the corrected GPS time may include identifying, through a frame synchronizer, a start point of a frame in the coherently integrated SBAS signal and outputting a frame sync time that represents a GPS time at which the SBAS signal transmitted from an SBAS satellite located in a GEO is received through the antenna, and generating, through a GPS time generator, a final GPS time using a GEO transmit time that represents a GPS time at which the SBAS signal included in the time synchronization information is transmitted from the SBAS satellite and the frame sync time.

The method may further include calculating a pseudo range between the SBAS satellite and the time synchronization apparatus based on position information of the SBAS satellite and position information of the time synchronization apparatus, and deriving a radio wave propagation time corresponding to a real range by correcting a signal delay caused by the ionosphere and the troposphere during atmospheric propagation of the SBAS signal using signal correction information included in the time synchronization information for the calculated pseudo range, and deriving the real range based on the derived radio wave propagation time.

The generating of the final GPS time may include generating the final GPS time by applying the corrected radio wave propagation time, derived by the real range deriver, to the frame sync time.

The receiving of the SBAS message may include receiving the SBAS message through at least one terrestrial network among 5G, LTE, and Wi-Fi.

According to embodiments, time synchronization with high reliability may be provided even under jamming environments by combining an SBAS signal and an auxiliary channel.

According to embodiments, a maximized SNR may be secured by performing long-term coherent integration on the SBAS signal.

According to embodiments, bit inversion of the SBAS signal may be resolved by receiving an SBAS message in advance through the auxiliary channel.

### BRIEF DESCRIPTION OF THE DRAWINGS

With regard to the description of the drawings, the same or similar reference numerals may be used to refer to the same or similar components.

FIG. 1 is a diagram illustrating a global positioning system (GPS) and a satellite-based augmentation system (SBAS)-based anti-jamming time synchronization system according to an embodiment.

FIG. 2 is a detailed block diagram illustrating a time synchronization apparatus according to an embodiment.

FIG. 3 is a diagram illustrating a time synchronization method performed by a time synchronization apparatus according to an embodiment.

### DETAILED DESCRIPTION

The following detailed structural or functional description is provided as an example only and various alterations and modifications may be made to the embodiments. Accordingly, the embodiments are not to be construed as limited to the disclosure and should be understood to include all changes, equivalents, or replacements within the idea and the technical scope of the disclosure.

As used herein, "A or B", "at least one of A and B", "at least one of A or B", "A, B or C", "at least one of A, B and C", "at least one of A, B, or C", and "one or a combination of at least two of A, B, and C," each of which may include any one of the items listed together in the corresponding one of the phrases, or all possible combinations thereof. Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is "connected", "coupled", or "joined" to another component, a third component may be "connected", "coupled", and "joined" between the first and second components, although the first component may be directly connected, coupled, or joined to the second component.

The singular forms "a", "an", and "the" include the plural forms as well, unless the context clearly indicates otherwise. It will be further understood that the terms "comprises/comprising" and/or "includes/including" when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms have the same meaning as commonly understood by one of ordinary skill in the art to which examples belong. Terms, such as those defined in commonly used dictionaries, are to be interpreted as having a meaning that is consistent with their meaning in the context of the relevant art and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

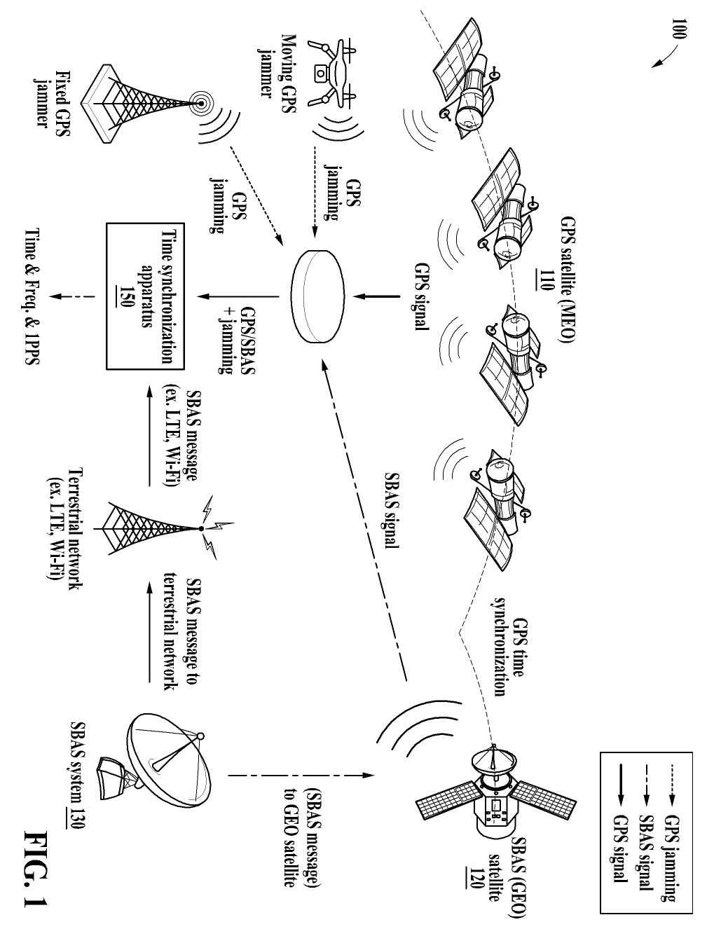

FIG. 1 is a diagram illustrating a global positioning system (GPS) and a satellite-based augmentation system (SBAS)-based anti-jamming time synchronization system according to an embodiment.

Referring to FIG. 1, an anti-jamming time synchronization system 100 may include a GPS satellite 110, an SBAS satellite 120, an SBAS system 130, a terrestrial network 140, and a time synchronization apparatus 150. However, the components included in the anti-jamming time synchronization system 100 of FIG. 1 are merely illustrative, and it will be understood by those skilled in the art that additional general components other than those shown in FIG. 1 may also be included.

The GPS satellite 110 is in a medium earth orbit (MEO) and may transmit a GPS signal including current position information of the satellite and time information (e.g., GPS time) generated based on a high-precision atomic clock. In this case, the GPS satellite 110 may transmit the GPS signal in the L1 band (1575.42MHz) using a code division multiple access (CDMA) method.

The SBAS satellite 120 is in a geostationary earth orbit (GEO) and may transmit an SBAS signal that may correct position information and time information included in a GPS signal. In this case, the SBAS satellite 120 may transmit the SBAS signal in the L1 band, like the GPS satellite 110. Since the SBAS satellite 120 is in the GEO and there is no Doppler frequency shift, the present disclosure may maximize the signal-to-noise ratio (SNR) by performing long-term coherent integration on the SBAS signal.

The SBAS system 130 is a terrestrial-based correction system designed to improve the accuracy of GPS signals and may generate an SBAS message including orbit information (e.g., position, velocity) of the SBAS satellite 120, time information, and GPS correction information, and may transmit the generated SBAS message to the SBAS satellite 120. More specifically, the SBAS system 130 may analyze GPS signals received from the GPS satellite 110 and may generate GPS correction information that corrects orbit errors, time errors, and atmospheric errors of the GPS satellite 110. The SBAS system 130 may then include this GPS correction information in the SBAS message and transmit it to the SBAS satellite 120.

For example, currently operating major SBAS systems 130 may include the Wide Area Augmentation System (WAAS) in the United States, the European Geostationary Navigation Overlay Service (EGNOS) in Europe, the MTSAT Satellite-Based Augmentation System (MSAS) in Japan, the GPS-Aided GEO Augmented Navigation (GAGAN) in India, and the Korea Augmentation Satellite System (KASS) in Korea.

The terrestrial network 140 may deliver an SBAS message generated by the SBAS system 130 to the time synchronization apparatus 150 through an auxiliary channel. For example, the terrestrial network 140 may include at least one of 5th generation (5G), Long Term Evolution (LTE), and Wi-Fi. However, such a configuration of the terrestrial network 140 is merely illustrative and is not limited to the foregoing examples.

The time synchronization apparatus 150 may receive GPS and SBAS signals through an antenna and may synchronize GPS time based on the received signals. In this case, the time synchronization apparatus 150 may also receive in advance an SBAS message generated by the SBAS system 130 from the terrestrial network 140 through an auxiliary channel.

Accordingly, the time synchronization apparatus 150 may use a received SBAS message to maintain accurate GPS time synchronization even in jamming environments caused by a fixed GPS jammer 160 or a mobile GPS jammer 170.

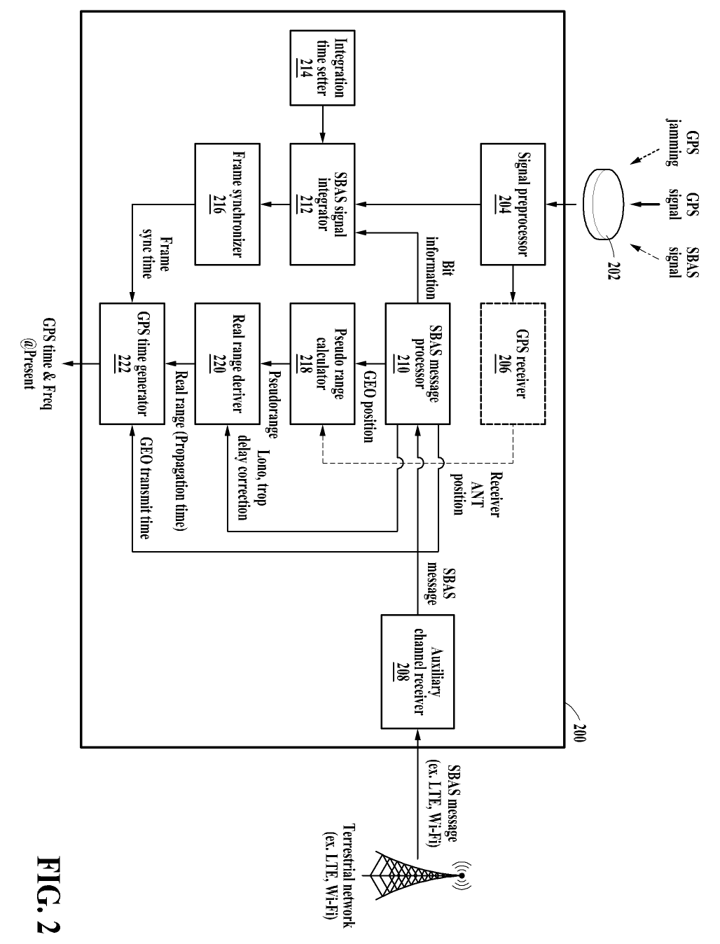

FIG. 2 is a detailed block diagram illustrating a time synchronization apparatus according to an embodiment.

Referring to FIG. 2, a time synchronization apparatus 200 may include an antenna 202, a signal preprocessor 204, a GPS receiver 206, an auxiliary channel receiver 208, an SBAS message processor 210, an SBAS signal integrator 212, an integration time setter 214, a frame synchronizer 216, a pseudo range calculator 218, a real range deriver 220, and a GPS time generator 222. However, the components included in the time synchronization apparatus 200 of FIG. 2 are merely illustrative, and it will be understood by those skilled in the art that additional general components other than those shown in FIG. 2 may also be included. The time synchronization apparatus 200 of FIG. 2 may be the same as the time synchronization apparatus 150 of FIG. 1.

The antenna 202 may receive both a GPS signal in the L1 frequency band transmitted from a GPS satellite (e.g., the GPS satellite 110 of FIG. 1) and an SBAS signal transmitted from an SBAS satellite (e.g., the SBAS satellite 120 of FIG. 1). If jamming environments are caused by jammers (e.g., the fixed GPS jammer 160 or the mobile GPS jammer 170 of FIG. 1), the antenna 202 may also receive GPS jamming signals. Although FIG. 2 illustrates the antenna 202 as being located outside the time synchronization apparatus 200, this is merely illustrative, and the antenna 202 may instead be located inside the time synchronization apparatus 200.

The signal preprocessor 204 may preprocess RF signals received by the antenna 202. More specifically, the signal preprocessor 204 may convert the RF signals (i.e., GPS and SBAS signals) received by the antenna 202 into an intermediate frequency (IF) signal or a baseband signal for digital signal processing.

In addition, because GPS and SBAS signals, which are RF signals, are received with very low signal strength, the signal preprocessor 204 may perform signal amplification using a signal amplifier (e.g., a low noise amplifier (LNA)).

Meanwhile, since GPS and SBAS signals are transmitted in the same L1 band, the signal preprocessor 204 may perform signal filtering to remove interference signals. For example, the signal preprocessor 204 may use a band pass filter (BPF) corresponding to the L1 band to filter the signals, thereby removing interference signals generated in GPS jamming environments and extracting effective signals for GPS time synchronization.

The GPS receiver 206 may synchronize GPS time using effective signals (i.e., GPS signals) extracted by the signal preprocessor 204. However, GPS signals may not be readily received in jamming environments. Accordingly, the present disclosure may provide a method of maintaining GPS time using SBAS signals.

To this end, the auxiliary channel receiver 208 may receive an SBAS message generated by an SBAS system (e.g., the SBAS system 130 of FIG. 1) through a terrestrial network (e.g., the terrestrial network 140 of FIG. 1). For example, the auxiliary channel receiver 208 may receive the SBAS message through at least one of 5G, LTE, and Wi-Fi. However, such a type of terrestrial network is merely illustrative and is not limited to the foregoing examples.

The SBAS message processor 210 may extract time synchronization information from an SBAS message received through the auxiliary channel receiver 208. More specifically, the SBAS message may include, as time synchronization information, at least one of time correction information for correcting time errors of a GPS satellite, signal correction information for correcting signal delays caused by the ionosphere and the troposphere, a GEO transmit time indicating a transmission time of an SBAS signal from an SBAS satellite, orbit information, and bit information for resolving bit inversion in the SBAS signal.

The SBAS signal integrator 212 may perform coherent integration on an SBAS signal received through the antenna 202. As described above, since SBAS signals are transmitted with very low signal strength, coherent integration may be necessary for stable signal reception. Because SBAS signals are transmitted from a GEO satellite, Doppler shift is minimal, which enables long-term coherent integration. When long-term coherent integration is performed on SBAS signals in this way, the SNR may increase due to the accumulation of information included in the SBAS signals, thereby enabling stable signal restoration even in jamming environments.

However, SBAS signals may undergo bit flipping every 2 milliseconds (ms) due to their low transmission rate of 500 samples per second (sps). Accordingly, the SBAS signal integrator 212 may maximize the effectiveness of coherent integration by resolving bit inversion using time synchronization information extracted by the SBAS message processor 210.

More specifically, the SBAS signal integrator 212 may align the phase of an SBAS signal through correlation with a reference signal. Then, the SBAS signal integrator 212 may identify a bit inversion point of the SBAS signal using bit information included in the time synchronization information to resolve a bit inversion and may invert data at the identified bit inversion point, thereby enabling long-term coherent integration.

The integration time setter 214 may set the integration time of the SBAS signal integrator 212. The integration time serves as a key parameter for enabling the SBAS signal integrator 212 to perform long-term coherent integration.

As the integration time increases, the energy of SBAS signals may accumulate, thereby improving the SNR. This, in turn, plays an important role in enhancing the stability of SBAS signal reception, particularly in jamming environments, and may enable stable GPS time synchronization.

Since the sample rate of an SBAS receiver is generally 500 sps, coherent integration may typically be performed for approximately 2ms. However, if the integration time is extended to longer durations such as 1 second or 10 seconds, the SNR gain may increase significantly.

For example, the SNR gain from coherent integration increases proportionally with the integration time. Accordingly, if the integration time is extended from 2ms to 1 second, approximately 1s/2ms=500 times more energy is accumulated, which theoretically results in approximately a 10*log(500) ≈ 27dB SNR gain. Likewise, if the integration time is extended from 2ms to 10 seconds, approximately 1s/2ms=5000 times more energy is accumulated, which theoretically results in approximately a 10*log(5000) ≈ 37dB SNR gain.

Accordingly, the time synchronization apparatus 200 in the present disclosure may maximize the SNR gain by increasing the integration time over an extended period. This may enable stable reception of SBAS signals even in jamming environments, thereby enabling more stable GPS time synchronization.

The frame synchronizer 216 may improve the accuracy of bit interpretation by aligning frame synchronization in SBAS signals. More specifically, if the SBAS signals have a periodically repeating frame structure, the frame synchronizer 216 may achieve frame synchronization by detecting a specific synchronization pattern based on the frame structure.

The frame synchronizer 216 may identify a start point of a frame in a frame-synchronized SBAS signal and output a frame sync time representing a GPS time when an SBAS signal transmitted from an SBAS satellite (e.g., a GEO satellite) is received through the antenna 202.

For example, three frame sync patterns (e.g., 01010011, 10011010, 11000110) may be used cyclically in an SBAS signal. The frame synchronizer 216 may identify the start point of a frame by detecting a match with one of these frame sync patterns. The start point of the frame indicates the time at which an SBAS signal is transmitted from a transmission antenna of an SBAS satellite, and this time may be synchronized with a GPS system. Meanwhile, the start time of the frame may be included in an SBAS message.

The pseudo range calculator 218 may calculate a pseudo range between an SBAS satellite and the time synchronization apparatus 200 based on the position information of the SBAS satellite and the position information of the time synchronization apparatus 200. The position information of the SBAS satellite may be included in the time synchronization information of an SBAS message, and the position information of the time synchronization apparatus 200 may be pre-measured by the GPS receiver 206.

Alternatively, the pseudo range calculator 218 may calculate a pseudo range between the SBAS satellite and the time synchronization apparatus 200 by calculating radio wave propagation time using the frame sync time and the GEO transmit time.

The pseudo range calculated in this way is a value not corrected for signal delays caused by the ionosphere and the troposphere during atmospheric propagation of the SBAS signal and thus may include an error when compared to the real range.

The real range deriver 220 may derive a corrected radio wave propagation time corresponding to a real range by correcting signal delays caused by the ionosphere and the troposphere during atmospheric propagation of the SBAS signal, using signal correction information included in the time synchronization information for the calculated pseudo range.

The GPS time generator 222 may generate a final GPS time using the GEO transmit time and the frame sync time. In this case, the GPS time generator 222 may generate a more accurate GPS time by further applying a corrected radio wave propagation time corresponding to a real range, which is derived by the real range deriver 220.

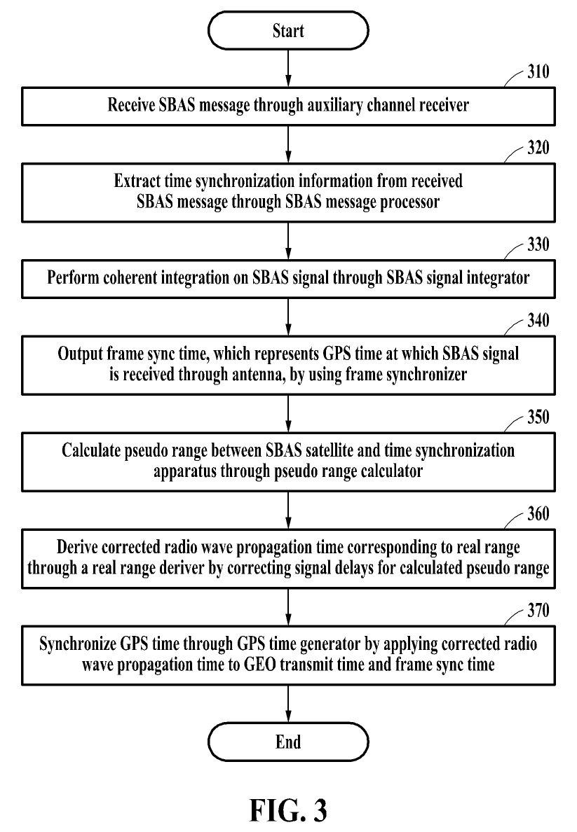

FIG. 3 is a diagram illustrating a time synchronization method performed by a time synchronization apparatus according to an embodiment. In an embodiment, at least one of operations of FIG. 3 may be simultaneously or parallelly performed with one another, and the order of the operations may be changed. In addition, at least one of the operations may be omitted or another operation may be additionally performed.

In operation 310, the time synchronization apparatus may receive an SBAS message through an auxiliary channel receiver. For example, the auxiliary channel receiver may receive the SBAS message through at least one terrestrial network among 5G, LTE, or Wi-Fi. However, the type of terrestrial network is merely illustrative and is not limited to these examples.

In operation 320, the time synchronization apparatus may extract time synchronization information from the received SBAS message through an SBAS message processor. More specifically, the SBAS message may include, as time synchronization information, at least one of time correction information for correcting time errors of a GPS satellite, signal correction information for correcting signal delays caused by the ionosphere and the troposphere, a GEO transmit time indicating a transmission time of an SBAS signal from an SBAS satellite, orbit information, and bit information for resolving bit inversion in the SBAS signal.

In operation 330, the time synchronization apparatus may perform coherent integration on an SBAS signal received through an antenna by using an SBAS signal integrator, based on bit information included in the time synchronization information. In this case, the SBAS signal integrator may maximize the effectiveness of coherent integration by resolving bit inversion using the time synchronization information extracted by the SBAS message processor.

More specifically, the SBAS signal integrator may align the phase of the SBAS signal through correlation with a reference signal. Then, the SBAS signal integrator may identify a bit inversion point of the SBAS signal using bit information, included in the time synchronization information, for resolving bit inversion and may then invert the data at the identified bit inversion point, thereby enabling long-term coherent integration.

In operation 340, the time synchronization apparatus may identify a start point of a frame in the coherently integrated SBAS signal and output a frame sync time, which represents a GPS time at which an SBAS signal transmitted from an SBAS satellite located in a GEO is received through the antenna, by using a frame synchronizer.

In operation 350, the time synchronization apparatus may calculate a pseudo range between an SBAS satellite and the time synchronization apparatus through a pseudo range calculator, based on the position information of the SBAS satellite and the position information of the time synchronization apparatus. In this case, the position information of the SBAS satellite may be included in the time synchronization information of the SBAS message, and the position information of the time synchronization apparatus may be pre-measured by the GPS receiver.

In operation 360, the time synchronization apparatus may derive a corrected radio wave propagation time corresponding to a real range through a real range deriver by correcting signal delays caused by the ionosphere and the troposphere during atmospheric propagation of the SBAS signal, using signal correction information included in the time synchronization information for the calculated pseudo range.

In operation 370, the time synchronization apparatus may synchronize GPS time through a GPS time generator by applying a corrected radio wave propagation time to a GEO transmit time, which represents a GPS time at which an SBAS signal is transmitted from an SBAS satellite, and to a frame sync time.

The examples described herein may be implemented by using a hardware component, a software component, and/or a combination thereof. For example, the devices, the methods, and the components described in the embodiments may be implemented using a general-purpose or special-purpose computer, such as a processor, a controller and an arithmetic logic unit (ALU), a digital signal processor (DSP), a microcomputer, a field programmable gate array (FPGA), a programmable logic unit (PLU), a microprocessor, or any other devices capable of responding to and executing instructions. The processing device may run an operating system (OS) and one or more software applications that run on the OS. The processing unit also may access, store, manipulate, process, and generate data in response to execution of the software. For purpose of simplicity, the description of a processing unit is used as singular; however, one skilled in the art will appreciate that a processing unit may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing unit. The software also may be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other examples, and equivalents to the claims are also within the scope of the following claims.

What is claimed is:

1. A time synchronization apparatus comprising:
an auxiliary channel receiver configured to receive a satellite-based augmentation system (SBAS) message through an auxiliary channel;
an SBAS message processor configured to extract time synchronization information from the received SBAS message;
an SBAS signal integrator configured to perform coherent integration on an SBAS signal received through an antenna, based on bit information included in the time synchronization information;
a frame synchronizer configured to identify a start point of a frame in the coherently integrated SBAS signal and to output a frame sync time, which represents a global positioning system (GPS) time at which the SBAS signal transmitted from an SBAS satellite located in a geostationary earth orbit (GEO) is received through the antenna; and
a GPS time generator configured to generate a final GPS time using a GEO transmit time, which represents a GPS time at which the SBAS signal included in the time synchronization information is transmitted from the SBAS satellite and the frame sync time.

2. The time synchronization apparatus of claim 1, further comprising:
a pseudo range calculator configured to calculate a pseudo range between the SBAS satellite and the time synchronization apparatus, based on position information of the SBAS satellite and position information of the time synchronization apparatus; and
a real range deriver configured to derive a radio wave propagation time corresponding to the real range, the radio wave propagation time being derived by correcting a signal delay caused by the ionosphere and the troposphere during atmospheric propagation of the SBAS signal using signal correction information included in the time synchronization information for the calculated pseudo range.

3. The time synchronization apparatus of claim 2, wherein the GPS time generator is configured to generate the final GPS time by applying the corrected radio wave propagation time, derived by the real range deriver, to the frame sync time.

4. The time synchronization apparatus of claim 1, wherein the SBAS signal integrator is configured to:
align a phase of the SBAS signal through correlation with a reference signal;
identify a bit inversion point in the phase-aligned SBAS signal using bit information included in the time synchronization information; and
perform integration on the phase-aligned SBAS signal by inverting data at the identified bit inversion point.

5. The time synchronization apparatus of claim 1, wherein the auxiliary channel receiver is configured to receive a message through at least one terrestrial network among 5th generation (5G), Long Term Evolution (LTE), and Wi-Fi.

6. A time synchronization method performed by a time synchronization apparatus, the time synchronization method comprising:
receiving a satellite-based augmentation system (SBAS) message through an auxiliary channel;
extracting time synchronization information from the received SBAS message;
performing coherent integration on an SBAS signal received through an antenna, based on bit information included in the time synchronization information;
identifying, through a frame synchronizer, a start point of a frame in the coherently integrated SBAS signal and outputting a frame sync time, which represents a global positioning system (GPS) time at which the SBAS signal transmitted from an SBAS satellite located in a geostationary earth orbit (GEO) is received through the antenna; and
generating, through a GPS time generator, a final GPS time using a GEO transmit time, which represents a GPS time at which the SBAS signal included in the time synchronization information is transmitted from the SBAS satellite and the frame sync time.

7. The time synchronization method of claim 6, further comprising:
calculating, through a pseudo range calculator, a pseudo range between the SBAS satellite and the time synchronization apparatus, based on position information of the SBAS satellite and position information of the time synchronization apparatus; and
deriving, through a real range deriver, a radio wave propagation time corresponding to the real range, the radio wave propagation time being derived by correcting a signal delay caused by the ionosphere and the troposphere during atmospheric propagation of the SBAS signal using signal correction information included in the time synchronization information for the calculated pseudo range.

8. The time synchronization method of claim 7, wherein the generating of the final GPS time comprises:
generating the final GPS time by applying the corrected radio wave propagation time, derived by the real range deriver, to the frame sync time.

9. The time synchronization method of claim 7, wherein the performing of the coherent integration comprises:
aligning a phase of the SBAS signal through correlation with a reference signal;
identifying a bit inversion point in the phase-aligned SBAS signal using bit information included in the time synchronization information; and
performing integration on the phase-aligned SBAS signal by inverting data at the identified bit inversion point.

10. The time synchronization method of claim 6, wherein the receiving of the SBAS message is performed through at least one terrestrial network among 5th generation (5G), Long Term Evolution (LTE), and Wi-Fi.

11. A time synchronization method performed by a time synchronization apparatus, the time synchronization method comprising:
synchronizing a global positioning system (GPS) time using a GPS signal received from a GPS satellite;
correcting the synchronized GPS time using a satellite-based augmentation system (SBAS) signal transmitted from an SBAS satellite located in a geostationary earth orbit (GEO); and
maintaining the corrected GPS time using the SBAS signal if the GPS signal is not received due to jamming.

12. The time synchronization method of claim 11, further comprising:
receiving an SBAS message through an auxiliary channel; and
performing coherent integration on the SBAS signal based on bit information included in time synchronization information contained in the SBAS message.

13. The time synchronization method of claim 12, wherein the performing of the coherent integration comprises:
aligning a phase of the SBAS signal through correlation with a reference signal;
identifying a bit inversion point in the phase-aligned SBAS signal using bit information included in the time synchronization information; and
performing integration on the phase-aligned SBAS signal by inverting data at the identified bit inversion point.

14. The time synchronization method of claim 11, wherein the maintaining of the corrected GPS time comprises:
identifying, through a frame synchronizer, a start point of a frame in the coherently integrated SBAS signal and outputting a frame sync time, which represents a global positioning system (GPS) time at which the SBAS signal transmitted from an SBAS satellite located in a geostationary earth orbit (GEO) is received through the antenna; and
generating, through a GPS time generator, a final GPS time using a GEO transmit time, which represents a GPS time at which the SBAS signal included in the time synchronization information is transmitted from the SBAS satellite and the frame sync time.

15. The time synchronization method of claim 14, further comprising:
calculating, through a pseudo range calculator, a pseudo range between the SBAS satellite and the time synchronization apparatus, based on position information of the SBAS satellite and position information of the time synchronization apparatus; and
deriving, through a real range deriver, a radio wave propagation time corresponding to the real range, the radio wave propagation time being derived by correcting a signal delay caused by the ionosphere and the troposphere during atmospheric propagation of the SBAS signal using signal correction information included in the time synchronization information for the calculated pseudo range.

16. The time synchronization method of claim 15, wherein the generating of the final GPS time comprises generating the final GPS time by applying the corrected radio wave propagation time, derived by the real range deriver, to the frame sync time.

17. The time synchronization method of claim 12, wherein the receiving of the SBAS message is performed through at least one terrestrial network among 5th generation (5G), Long Term Evolution (LTE), and Wi-Fi.
